(19) United States
(12) Patent Application Publication
(10) Pub. No.: US 2009/0133802 A1
(43) Pub. Date: May 28, 2009

(54) Welded Materials and Method For Making The Same

(76) Inventors: Adam S. Epstein, Wellesley, MA (US); Robert W. Pekar, Florence, MA (US); Stephen J. Wiater, Southwick, MA (US); Jeffrey Abramowicz, Springfield, MA (US)

Correspondence Address: CANTOR COLBURN, LLP, 20 Church Street, 22nd Floor, Hartford, CT, 06103, US

(21) Appl. No.: 11/946,350

(22) Filed: Nov. 28, 2007

(51) Int. Cl. B32B 37/06

(52) U.S. Cl. 156/73.1

(57) ABSTRACT

A method of welding materials includes obtaining a first material having a first thermoplastic layer formed thereon; obtaining a second thermoplastic layer; positioning the first material and the second thermoplastic layer such that the first thermoplastic layer faces the second thermoplastic layer; applying energy to the first thermoplastic layer and the second thermoplastic layer at a first location to establish a first weld; applying energy to the first thermoplastic layer and the second thermoplastic layer at a second location, the second location being offset from the first location, a portion of the second location overlapping a portion of the first location.

### BACKGROUND

This invention relates generally to welding materials and in particular, to welding thermoplastic materials, or thermoplastics and non-thermoplastics together, to form a seam having enhanced seam strength.

There exists in the art a number of applications for textiles having a thermoplastic material adhered thereto. For example, U.S. Pat. No. 6,350,709 discloses a textile substrate having a polymeric film, such as polyamide, polyolefin, or polyurethane laminated thereto. This textile substrate may be woven of nylon, polyester, or other synthetic fibers. U.S. Pat. No. 6,350,709 also discloses a method for heat sealing sheets of the laminated material to form an automotive air bag.

When forming structures from materials having a thermoplastic layer thereon, seams are formed by placing the materials between dies and applying energy. The polymeric films are bonded through melting and curing. A drawback to conventional seam forming techniques is the lack of techniques to enhance seam strength, especially with materials that form inherently weak bonds together. Regardless of the structure (e.g., air bag, clothing) enhanced seam strength is beneficial in meeting product performance requirements. Thus, there is a need in the art for methods for enhancing seam strength in products formed from textiles having a polymeric sheet laminated thereto.

### SUMMARY

Embodiments of the invention include a process for welding materials including obtaining a first material having a first thermoplastic layer formed thereon; obtaining a second thermoplastic layer; positioning the first material and the second thermoplastic layer such that the first thermoplastic layer faces the second thermoplastic layer; applying energy to the first thermoplastic layer and the second thermoplastic layer at a first location to establish a first weld; applying energy to the first thermoplastic layer and the second thermoplastic layer at a second location, the second location being offset from the first location, a portion of the second location overlapping a portion of the first location.

### BRIEF DESCRIPTION OF THE DRAWINGS

FIG. 1 is a cross-sectional view illustrating a step in a process of welding materials.

FIG. 2 is a cross-sectional view illustrating a step in the process of welding materials.

FIG. 3 is a cross-sectional view illustrating a step in the process of welding materials.

FIG. 4 is a cross-sectional view illustrating a step in the process of welding materials.

FIG. 5 is a plan view illustrating an exemplary welding pattern.

FIG. 6 is a plan view illustrating another exemplary welding pattern.

### DETAILED DESCRIPTION

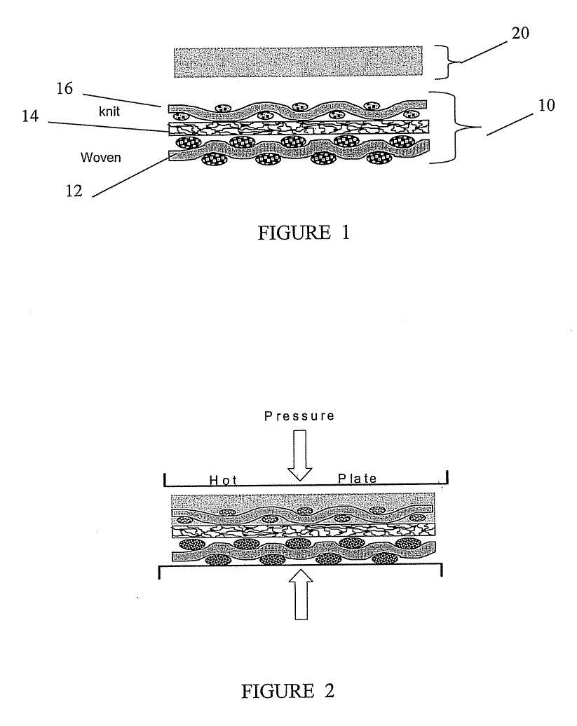

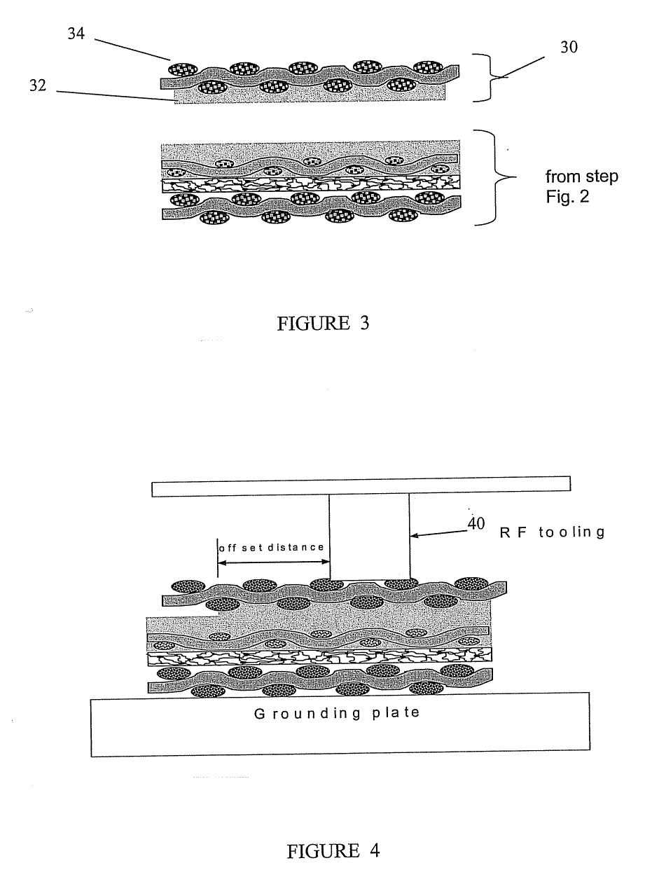

FIG. 1 is a cross-sectional view illustrating a step in a process of welding materials. At this initial stage, a thermoplastic layer 20 is formed on a surface of a material 10. The thermoplastic layer 20 may be a polymeric sheet film such as a polyurethane film. Alternatively, the thermoplastic layer 20 may be formed by applying a resin, rather than a film. The thermoplastic film may be formed from a blown resin, extruded resin, molded resin, etc. The material 10 shown in FIG. 1 is a 3-layer laminate that is moisture permeable while being air-permeable or non air-permeable. In exemplary embodiments, the 3-layer laminate includes a woven layer 12, a non-woven layer 14 and a knit layer 16. The material 10 may be an expanded polytetrafluoroethylene (PTFE) material similar to part No WAAZ 103604A, or part No. WCJX 145103D from W.L. Gore & Associates, Elkton, Md. This laminate 10 may be prepared generally according to the teachings of U.S. Pat. No. 4,194,041. It is understood that other materials may be used for material 10. In the next step shown in FIG. 2, the polymeric film 20 is bonded to the material 10 by applying energy through a heat press. It is understood that other techniques may be used to bond layer 20 to material 10 such as RF or ultrasonic welding. A variety of thermoplastic welding techniques may be used including RF, ultrasonic, impulse, hot plate, hot air, etc. The welding process heats up the thermoplastic layer 20 to the point that it flows into material 10. As shown in FIG. 2, during the heat press process, the thermoplastic layer 20 melts and becomes embedded in the knit layer 16 of material 10. This forms a secure mechanical bond between the thermoplastic layer 20 and material 10.

FIG. 3 illustrates the next step in which a second thermoplastic-coated material 30 (e.g., part No. PS 8010 from Deerfield Urethane Inc, Whately, Mass.) is placed on thermoplastic layer 20. The second thermoplastic-coated material 30 may include a textile 34 and a thermoplastic (e.g., polymeric) layer 32 bonded thereto. The thermoplastic layer 32 may be polyurethane in exemplary embodiments. The thermoplastic layer 32 is placed so as to face the thermoplastic layer 20. In alternate embodiments, the second material 30 may omit the textile layer so as to only include a thermoplastic polymer layer 32.

As shown in FIG. 4, a welded seam is then formed by applying, for example, radio frequency energy and pressure using equipment such as a Thermatron 15KW Model KF 122. A variety of welding techniques may be used to apply energy including RF, ultrasonic, impulse, hot plate, hot air, etc. As depicted in FIG. 4, the RF tooling die 40 welds the thermoplastic layers 20 and 32. This process forms a bond between the thermoplastic layers 32 and 20. The welding process pushes the thermoplastic (meltable) material into the pores in material 10 and causes a mechanical bond between the infused thermoplastic layers and the material 10.

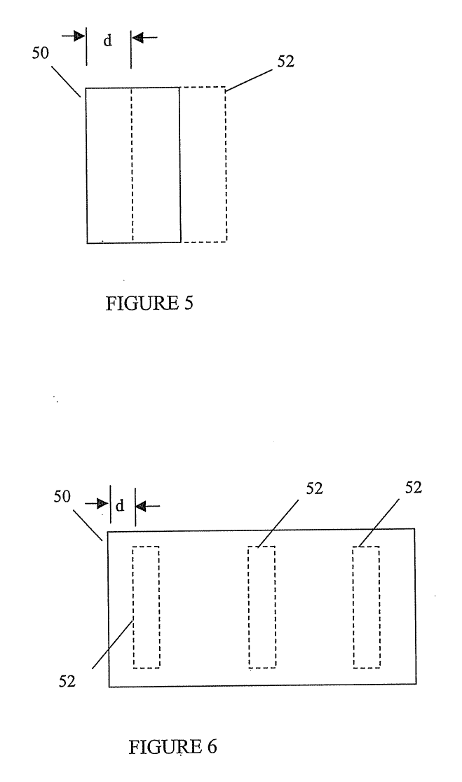

As shown in FIG. 4, the tooling die 40 is controlled so as to set an offset distance between multiple welds. An exemplary offset welding technique is illustrated in FIG. 5 which shows a top view of an exemplary weld. To form the multiple welds, a tooling die is used to form a first weld 50. The material is welded between the electrode and base plate as shown in FIG. 4. Then a second weld 52 is formed, offset by offset distance d and overlapping the first weld 50. This double weld technique drives the thermoplastic material from layers 20 and 32 further into the material 10 (whether a non-woven or porous woven surface is used) and creates an additional mechanical bond on top of the cohesive bond between the polymeric molecular chains, thus increasing weld strength.

An alternate offset weld is shown in FIG. 6. In FIG. 6, the first weld 50 has a larger size than subsequent welds 52. The subsequent welds 52 are offset from the edge of the first weld 50 and offset from each other. The multiple, offset welding provides a higher seam strength than conventional techniques.

Other techniques may be used to further increase the weld strength. One technique is to perform spot impregnation of thermoplastic material plastic into the material. By-preheating the welding tools, the thermoplastic layers 20 and 32 can be pushed further into the top knit layer 16 of material 10. With this thermoplastic/fabric construction it is possible to distribute tension over a greater surface area. This also improves weld strengths if material more resistant to tearing and fracturing when stressed is used. Lastly, with the thermoplastic material infused into the fibers of the fabric layer 16, the fabric stiffens and loses some of its stretch. The pre-heating can be done with heated tools, buffer materials, or double hits using the same tool die.

Using spot impregnation the molten thermoplastic is forced into a porous material and cured in place around material structure (e.g. threads). In some cases this structure is lubricious, or of a chemistry that has a tendency to reject the impregnation of the molten material. In such embodiments, the material 10 can also be prepared with various solvents or abrasives to make the fibers in the material (e.g., fibers in knit layer 16) more porous. The molten thermoplastic material can enter the pores of the fibers to more securely bond the polymeric layer to the fabric layer.

By prepping the substrate first, by heat or chemistry, it is easier to intertwine the thermoplastic layers 20 and 32 and the material 10. That is to say, the cured thermoplastic materials may wrap around structures in material 10, but their chemistry remains distinct.

In alternate embodiments, molecular chains on the surface of material 10 may be broken, for example with solvents, prior to welding the thermoplastic layer to the material 10 to promote better bonding. In these cases, a slurry is formed on the surface of the materials where there may be a mixing of the chemistry (at or not at the molecular level), but the thermoplastic layers 20 and 32 and the material 10 are cured together in the same general space.

In additional embodiments, the process is used to secure a thermoplastic layer to a first material that does not include a thermoplastic. For example, the double welding process may be used to secure a thermoplastic layer to a material (e.g. a fabric such as a woven fabric or non-woven fabric) without the need for a second thermoplastic layer.

While this invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method of welding materials comprising:
obtaining a first material having a first thermoplastic layer formed thereon;
obtaining a second thermoplastic layer;
positioning the first material and the second thermoplastic layer such that the first thermoplastic layer faces the second thermoplastic layer;
applying energy to the first thermoplastic layer and the second thermoplastic layer at a first location to establish a first weld;
applying energy to the first thermoplastic layer and the second thermoplastic layer at a second location, the second location being offset from the first location, a portion of the second location overlapping a portion of the first location.

2. The method of claim 1 wherein:
the first material includes expanded polytetrafluoroethylene (PTFE).

3. The method of claim 1 wherein:
the first material includes multiple layers, a knit layer being positioned adjacent to the first thermoplastic layer.

4. The method of claim 1 wherein:
the first thermoplastic layer is a polyurethane film.

5. The method of claim 1 wherein:
the applying energy includes using at least one of RF, ultrasonic, impulse, hot plate or hot air welding.

6. The method of claim 1 wherein:
the first material includes a porous layer facing the first thermoplastic layer, the applying energy to the first thermoplastic layer and the second thermoplastic layer causing the first thermoplastic layer and the second thermoplastic layer to melt and enter pores in the porous layer.

7. The method of claim 1 wherein:
the second thermoplastic layer is bonded to a textile.

8. The method of claim 1 wherein:
prior to applying energy to the first thermoplastic layer and the second thermoplastic layer a tool applying the energy is preheated.

9. The method of claim 1 wherein:
the first material is treated with a solvent prior to enhance bonding with the first thermoplastic layer.

10. The method of claim 1 wherein:
the first material is treated with abrasives prior to enhance bonding with the first thermoplastic layer.

11. The method of claim 1 wherein:
the entire second location overlaps a portion of the first location.

12. A method of welding materials comprising:
obtaining a first material;
obtaining a second thermoplastic layer;
positioning the first material and the second thermoplastic layer such that the first material faces the second thermoplastic layer;
applying energy to the first material and the second thermoplastic layer at a first location to establish a first weld;
applying energy to the first material and the second thermoplastic layer at a second location, the second location being offset from the first location, a portion of the second location overlapping a portion of the first location.
